(19) United States
(12) Patent Application Publication
(10) Pub. No.: US 2026/0299507 A1
(43) Pub. Date: Oct. 1, 2026

(54) IMAGE FORMING APPARATUS AND CLEANING MEMBER

(71) Applicant: CANON KABUSHIKI KAISHA, Tokyo (JP)

(72) Inventors: HITOSHI IWAI, Chiba (JP); TATSUYUKI YAMAMOTO, Tokyo (JP)

(21) Appl. No.: 19/553,900

(22) Filed: Mar. 2, 2026

(30) Foreign Application Priority Data
Mar. 28, 2025 (JP) 2025-055139

(51) Int. Cl. G03G 21/16; B08B 1/16; B08B 1/30; G03G 15/01; G03G 15/04

(52) U.S. Cl. CPC G03G 21/169; B08B 1/165; B08B 1/30; G03G 15/04045; G03G 15/011; G03G 15/0189

(57) ABSTRACT

A cleaning member for cleaning a light emission surface of a solid exposure unit in an image forming apparatus includes a cleaning portion configured to slide on and clean the light emission surface of the solid exposure unit, and a gripping portion configured to grip the cleaning member, the cleaning portion includes a first blade configured to clean the light emission surface of the solid exposure unit by abutting on the light emission surface of the solid exposure unit, and a second blade configured to manage a position where the first blade abuts on the light emission surface of the solid exposure unit by abutting on the light emission surface of the solid exposure unit, and having a shorter length on a side abutting on the light emission surface of the solid exposure unit than the first blade.

### BACKGROUND

### Field of the Technology

The present disclosure relates to an electrophotographic image forming apparatus such as a copying machine, a printer, a facsimile, or a multifunction machine having a plurality of these functions, and a cleaning member that cleans a light emission surface of a solid exposure unit for exposing a photosensitive drum in the image forming apparatus.

### Description of the Related Art

In an electrophotographic image forming apparatus such as a printer or a copying machine, there is a solid exposure unit as one unit for exposing a photosensitive drum and forming an electrostatic latent image. In the solid exposure unit, a plurality of light emission elements such as LEDs or organic ELs, which are light emission elements, are arranged along a rotational axis direction (main scanning direction) of the photosensitive drum, and the photosensitive drum is collectively exposed in the main scanning direction. This system has a smaller volume than a laser scanning exposure device using a polygon mirror for scanning and has no drive portion, and thus has a configuration advantageous for downsizing and noise reduction of an image forming apparatus.

The solid exposure unit is provided with a lens array in which a plurality of lenses is arranged in a main scanning direction to face the light emission elements in order to form an image of the light flux emitted from the light emission elements on the photosensitive drum. Since the lens array has a very short focal length, the solid exposure unit needs to be disposed very close to the photosensitive drum.

In the vicinity of the photosensitive drum, a toner may be floating on an air flow for cooling inside the apparatus. When such a floating toner adheres to a light emission surface of the lens array, there is a concern that the quantity of light irradiating the photoreceptor may be uneven and image defects such as density unevenness and white stripes may occur. Therefore, Japanese Patent No. 4848709 proposes a cleaning unit for removing dirt on a light emission surface of a solid exposure unit that causes such image defects.

However, in the configuration disclosed in Japanese Patent No. 4848709, a guide portion that manages a distance between the cleaning member and the solid exposure unit is required. Recent image forming apparatuses are required to be reduced in size, and the component mounting density inside the apparatus tends to increase. It may be difficult to provide the guide portion in the vicinity of the solid exposure unit.

In addition, a rubber blade is often used for cleaning the lens array of the solid exposure unit, and the contact state between the rubber blade and a lens array surface has a great influence on the performance of removing foreign matter on the lens array surface by the rubber blade. Specifically, an ideal state is to manage the amount of entry of the rubber blade with respect to the lens array surface within a certain range, and sweep the foreign matter away while an edge of the rubber blade properly abuts on the lens array surface without hitting the surface. In this case, if a guide portion is provided for this reason in a main body of the image forming apparatus, tolerances of various components accumulate, resulting in a large variation in the amount of entry of the rubber blade.

### SUMMARY

According to an aspect of the present disclosure, provided is a cleaning member for cleaning a light emission surface of a solid exposure unit in an image forming apparatus, including a cleaning portion provided on one end side of the cleaning member and configured to slide on and clean the light emission surface of the solid exposure unit, and a gripping portion provided on another end side of the cleaning member and configured to grip the cleaning member, in which the cleaning portion includes a first blade configured to clean the light emission surface of the solid exposure unit by abutting on the light emission surface of the solid exposure unit, and a second blade configured to manage a position where the first blade abuts on the light emission surface of the solid exposure unit by abutting on the light emission surface of the solid exposure unit, and having a shorter length on a side abutting on the light emission surface of the solid exposure unit than the first blade.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic front sectional view of an image forming apparatus according to an embodiment of the present disclosure;

FIG. 2 is an enlarged cross-sectional view of a solid exposure unit according to the embodiment of the present disclosure;

FIGS. 3A and 3B are perspective views showing a contact/release state of the solid exposure unit according to the embodiment of the present disclosure;

FIGS. 4A and 4B are front views showing a contact/release state of the solid exposure unit according to the embodiment of the present disclosure as viewed from the side;

FIG. 5 is a partially enlarged view of a connection portion between a link mechanism and the solid exposure unit according to the embodiment of the present disclosure;

FIG. 6 is a partial perspective view of the periphery of a main body cover of the image forming apparatus according to the embodiment of the present disclosure;

FIG. 7 is a perspective view showing an overall configuration of a cleaning member that cleans a lens array according to the embodiment of the present disclosure;

FIG. 8 is an explanatory view showing an insertion state of the cleaning member according to the embodiment of the present disclosure;

FIG. 9 is an enlarged view of the periphery of an insertion guide according to the embodiment of the present disclosure;

FIGS. 10A and 10B are detailed perspective views of a cleaning portion in the cleaning member according to the embodiment of the present disclosure;

FIGS. 11A and 11B are cross-sectional views of the cleaning portion in the cleaning member according to the embodiment of the present disclosure;

FIGS. 12A to 12C are partial cross-sectional views showing a positional relationship between the lens array, a cleaning blade, and a positioning blade when the cleaning member according to the embodiment of the present disclosure is inserted deeply; and

FIG. 13 is a cross-sectional view of a comparative example.

### DESCRIPTION OF THE EMBODIMENTS

Hereinafter, exemplary embodiments of the present disclosure will be described in detail with reference to the drawings. Note that constituent elements described in the following embodiments are merely examples, and various conditions such as configurations, functions, dimensions, materials, shapes, relative arrangements, and the like of an apparatus to which the present disclosure is applied can be appropriately modified or changed without departing from the gist of the present disclosure, and are not limited to the following embodiments.

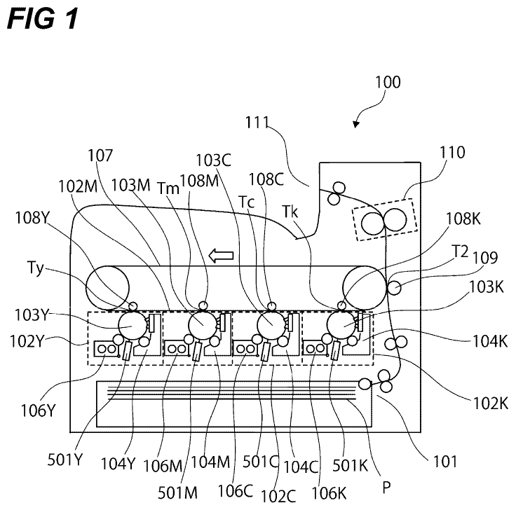

FIG. 1 is a schematic front sectional view of an image forming apparatus according to an embodiment of the present disclosure.

In FIG. 1, an image forming apparatus 100 includes four image forming portions 102Y, 102M, 102C, and 102K that form toner images of respective colors: yellow (Y); magenta (M); cyan (C); and black (K). The image forming portions 102Y, 102M, 102C, and 102K include photosensitive drums 103Y, 103M, 103C, and 103K, respectively. Chargers 104Y, 104M, 104C, and 104K, solid exposure units (LED) 501Y, 501M, 501C, and 501K, and development devices 106Y, 106M, 106C, and 106K are provided around the photosensitive drums 103Y, 103M, 103C, and 103K, respectively.

In the above configuration, image forming processing will be briefly described.

The photosensitive drums 103Y, 103M, 103C, and 103K uniformly charged by the chargers 104Y, 104M, 104C, and 104K are exposed by the solid exposure units 501Y, 501M, 501C, and 501K to form electrostatic latent images. The electrostatic latent images are developed as toner images of the respective colors by the development devices 106Y, 106M, 106C, and 106K, and are sequentially superimposed and transferred onto an intermediate transfer belt 107 by primary transfer rollers 108Y, 108M, 108C, and 108K in primary transfer portions Ty, Tm, Tc, and Tk.

The toner images of the respective colors superimposed onto the intermediate transfer belt 107 are collectively transferred by a secondary transfer roller 109 onto a recording sheet P transported from a sheet feeding portion 101 in a secondary transfer portion T2.

The recording sheet P to which the toner images have been transferred is transported to a fixing device 110. After the toner images are fixed to the recording sheet P by heat and pressure, the recording sheet P is ejected from a sheet ejection portion 111.

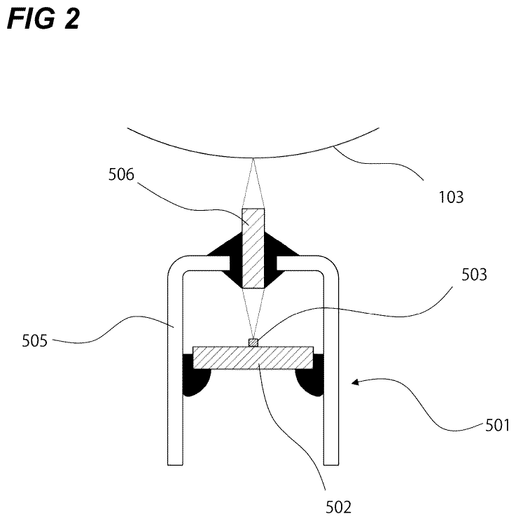

FIG. 2 is an enlarged sectional view of a solid exposure unit 501.

In FIG. 2, a light emission substrate 502 in which a plurality of LED chips as light emission elements is aligned and mounted in a main scanning direction (rotational axis direction of the photosensitive drum), and a lens array 506 in which a plurality of cylindrical refractive index distribution type lenses is similarly aligned in the main scanning direction are held in a housing 505. The material of the housing 505 is a plate material obtained by plating a galvanized steel plate or a cold-rolled steel plate later. The lens array 506 forms an image of the light flux emitted from an LED light emission point 503 on the photosensitive drum 103 as an unmagnified erect image. In this case, the distance from the LED light emission point 503 to the incident surface of the lens array 506 is substantially equal to the distance from the emission surface of the lens array 506 to the surface of the photosensitive drum 103.

The distance between the LED light emission point 503 and the incident surface of the lens array 506 is required to have high accuracy on the order of μm, and after the distance is precisely adjusted, the light emission substrate 502 and the lens array 506 are fixed to the housing 505 by adhesion. In the present embodiment, an LED is used as an exposure light source of the solid exposure unit 501, and an integrated unit of the light emission substrate 502, the lens array 506, and the housing 505 is referred to as the solid exposure unit 501.

Inside the image forming apparatus 100, the solid exposure unit 501 is configured to be movable between an exposure position during formation of a latent image and a retraction position during maintenance such as cleaning work. In the present embodiment, the contact/release mechanism and the above-described solid exposure unit 501 are collectively referred to as a solid exposure device 500.

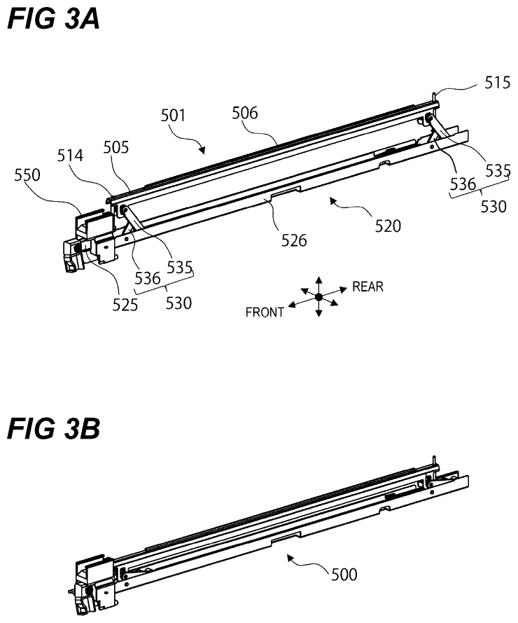

The contact/release mechanism of the solid exposure unit 501 with respect to the photosensitive drum 103 will be described with reference to FIGS. 3A and 3B. FIGS. 3A and 3B are perspective views showing a contact/release state of the solid exposure unit 501. FIG. 3A shows an exposure state in which the solid exposure unit 501 is lifted up to the vicinity of the photosensitive drum, and FIG. 3B shows a retraction state in which the solid exposure unit 501 is lowered and moved away from the photosensitive drum.

In FIGS. 3A and 3B, the solid exposure unit 501 is supported by link mechanisms 530 provided in front of and behind the solid exposure unit 501. The link mechanism 530 engages with a slide mechanism 520, and is lifted and lowered as the slide mechanism 520 moves forward and backward.

The slide mechanism 520 is formed of a slide frame 526 that is formed by bending a sheet metal into a U-shape and fixed to a main body of the apparatus, and a slide bar 525 that moves forward and backward inside the slide frame 526.

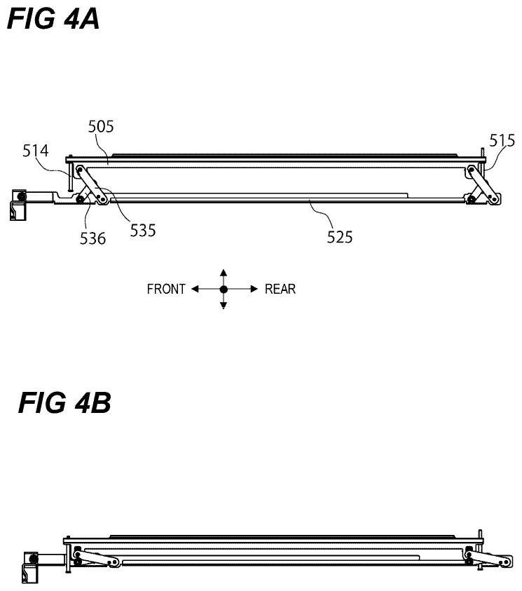

FIGS. 4A and 4B are front views showing a contact/release state of the solid exposure unit 501 as viewed from the side, and the slide frame 526 is omitted in order to make the lifting/lowering mechanism easily viewable.

In FIGS. 4A and 4B, the link mechanism 530 is formed of a large link 535 and a small link 536, and one end of the large link 535 is rotatably held by the slide bar 525. One end of the small link 536 is rotatably held by the slide frame 526 (not shown in FIGS. 4A and 4B) fixed to the main body, and the other end is rotatably engaged with the center of the large link 535. Therefore, in a state in which the slide frame 526 is fixed, when the slide bar 525 is pulled forward, one end of the large link 535 is lifted, and when the slide bar 525 is pushed backward, one end of the large link 535 is lowered.

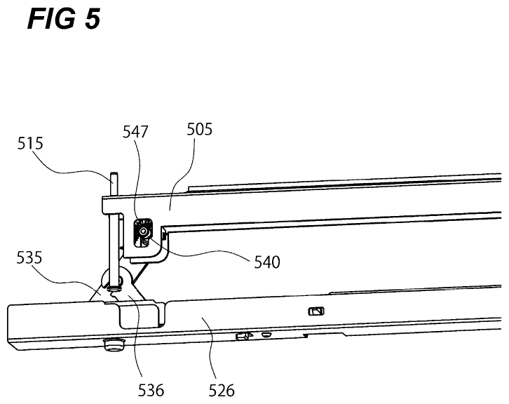

FIG. 5 is a partially enlarged view of a connection portion between the link mechanism 530 and the solid exposure unit 501, showing an exposure state in which the solid exposure unit 501 is lifted up to the vicinity of the photosensitive drum.

In FIG. 5, a cantilever shaft 540 is provided at an end portion of the large link 535. On the other hand, a torsion coil spring 547 is stretched across the housing 505 of the solid exposure unit 501, and the cantilever shaft 540 is in contact with a mid-section of the torsion coil spring 547 in a direction substantially orthogonal to the mid-section. When the large link 535 is lifted, the cantilever shaft 540 pushes the mid-section of the torsion coil spring 547, and indirectly pushes up the solid exposure unit 501.

In FIGS. 3A, 3B, 4A, 4B, and 5, the solid exposure unit 501 is provided with a pre-positioning pin 514 and a post-positioning pin 515. The positioning pin is made of a metal and is fixed to the housing 505 by welding or adhesion. When the solid exposure unit 501 is pushed up by the link mechanism 530, tips of the pre-positioning pin 514 and the post-positioning pin 515 are pressed against a predetermined abutting surface provided in a drum cartridge unit (not shown), and the solid exposure unit 501 stops lifting. In this case, the lifting stroke of the link mechanism 530 is set to be larger than a required amount, and the torsion coil spring 547 biases the solid exposure unit while absorbing the overstroke, so that the solid exposure unit can be reliably pressed against the drum cartridge unit.

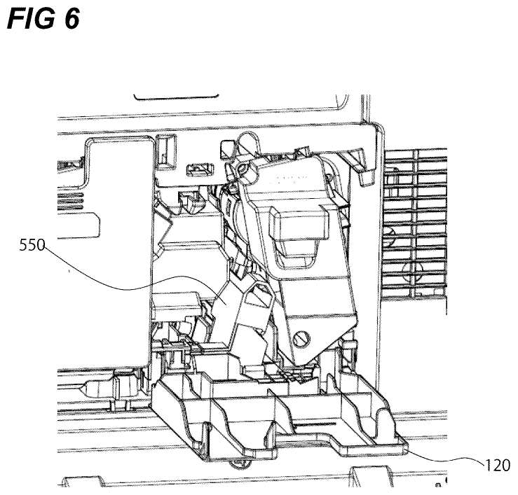

As an example of the operation of moving the slide bar 525, a configuration can be considered in which the slide bar 525 moves in conjunction with the opening/closing of a main body cover 120 provided on a front surface of the image forming apparatus 100 as shown in FIG. 6, which is a partial perspective view of the periphery of the main body cover of the image forming apparatus 100.

As described above, when foreign matter such as a toner adheres to the light emission surface of the lens array 506, the light emitted from the light emission elements is partially shielded, and the image quality of an output image is deteriorated. Therefore, it is necessary to periodically clean the light emission surface of the lens array 506.

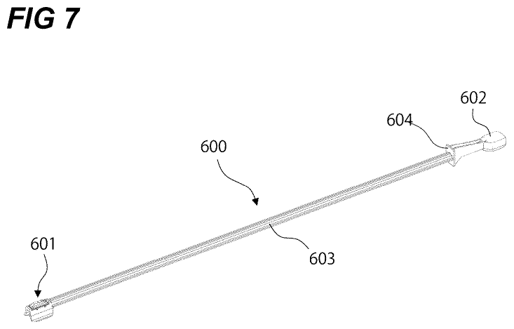

FIG. 7 is a perspective view illustrating an overall configuration of a cleaning member for cleaning the light emission surface of the lens array 506 according to the present embodiment.

In FIG. 7, a cleaning member 600 has an elongated rod shape as a whole, and includes a cleaning portion 601 that abuts on the lens array 506 and cleans the light emission surface of the lens array 506 on one end side of a rod-shaped body portion 603, and a gripping portion 602 for gripping the cleaning member 600 on the other end side. In addition, a stopper portion 604 is provided adjacent to the gripping portion 602.

In the present embodiment, the light emission surface of the lens array 506 in the solid exposure unit 501 is cleaned when the solid exposure unit 501 is in a retraction state in which it is moved away from the photosensitive drum 103. Specifically, for the cleaning of the light emission surface of the lens array 506 in the solid exposure unit 501, when the main body cover 120 shown in FIG. 6 is opened, the solid exposure unit 501 moves to the retraction position in conjunction with the above-described opening. In this state, the gripping portion 602 of the cleaning member 600 is gripped, and the cleaning portion 601 is slid in a reciprocating manner while abutting on the lens array 506.

Usually, when the cleaning member 600 reciprocates, in order to ensure the contact between the cleaning portion 601 and the lens array 506, a guide mechanism that regulates the position of the solid exposure unit 501 in an optical axis direction with respect to the cleaning member is required to be provided in the vicinity of the solid exposure unit in the main body of the image forming apparatus 100 or the housing of the solid exposure unit 501. However, when such a guide mechanism is provided in the vicinity of the solid exposure unit, a space for the guide mechanism is required around the solid exposure unit 501, distances between the photosensitive drums of the respective colors are extended, and the image forming apparatus 100 is increased in size.

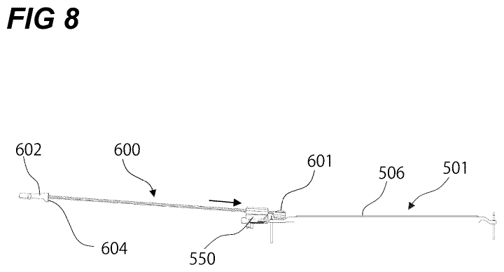

Therefore, in the present embodiment, in order to prevent the image forming apparatus 100 from being increased in size, instead of providing such a guide mechanism in the vicinity of the solid exposure unit 501 in the main body of the image forming apparatus 100, an insertion guide 550 is provided as a guide portion with an angle for inserting the cleaning member 600 downward relative to the horizontal (in a direction in which it abuts on the lens array 506) outside the light emission surface of the solid exposure unit 501 in a direction in which the cleaning member 600 enters, as shown in FIG. 8 showing the insertion state of the cleaning member 600. Therefore, the entire body portion 603 of the cleaning member 600 bends into a downward convex shape during the cleaning operation, and the cleaning portion 601 at the tip always abuts on the lens array 506. The body portion 603 of the cleaning member 600 is formed of engineering plastic such as ABS or PP, and is not easily broken even during cleaning.

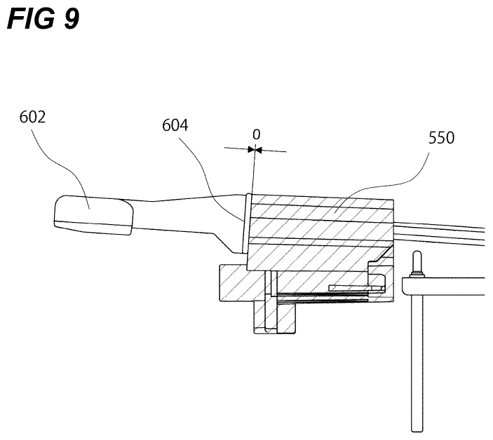

In addition, as shown in FIG. 9 that is an enlarged view of the periphery of the insertion guide 550, when the cleaning member 600 is inserted to the deepest portion, the stopper portion 604 of the cleaning member 600 abuts on the insertion guide 550 to stop the cleaning member 600 at a predetermined position, and the cleaning member cannot be inserted any further.

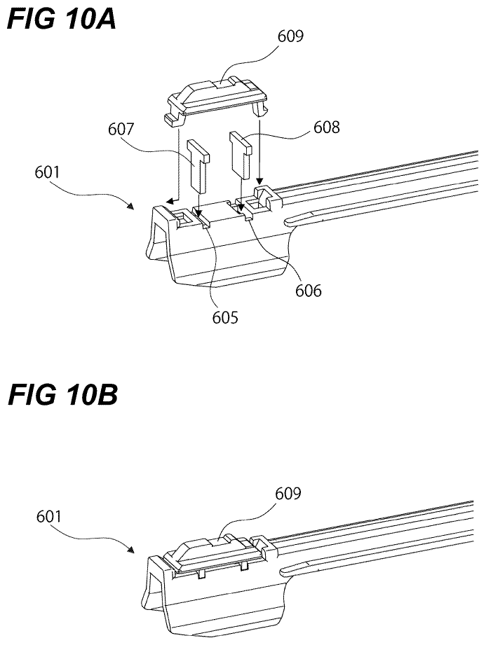

FIGS. 10A and 10B are detailed perspective views of the cleaning portion 601 in the cleaning member 600. FIG. 10A is an exploded perspective view of the cleaning portion 601, and FIG. 10B is an assembled perspective view of the cleaning portion 601.

In FIGS. 10A and 10B, the cleaning portion 601 is provided with a first groove portion 605 and a second groove portion 606. A T-shaped cleaning blade 607 is inserted into the first groove portion 605 that is close to the tip of the cleaning member 600 and positioned ahead in a forward path of the cleaning operation, and a T-shaped positioning blade 608 is inserted into the second groove portion 606 that is closer to the gripping portion 602 than the first groove portion 605. T-shaped horizontal portions of the blades 607 and 608 are supported by bottom surfaces of the first groove portion 605 and the second groove portion 606, so that the blades do not fall down. Upper surfaces of the blades 607 and 608 are covered with a cover member 609 attached to the cleaning portion 601 by snap-fit, and the blades do not fall out upward also.

The cleaning blade 607 and the positioning blade 608 are each made of urethane rubber having a thickness of 1 mm. As a characteristic of the shape, the cleaning blade 607 has a longer length than the positioning blade 608 in a height direction (in a direction abutting on the lens array 506). Meanwhile, the positioning blade 608 has a wider width than the cleaning blade 607 in a width direction (in a T-shape direction orthogonal to the height direction).

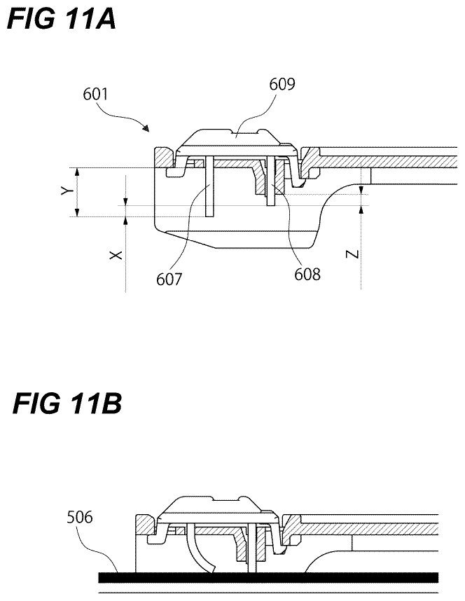

FIGS. 11A and 11B are cross-sectional views of the cleaning portion 601 in the cleaning member 600. FIG. 11A shows a dimensional relationship of positions of respective tips of the cleaning blade 607 and the positioning blade 608, and FIG. 11B shows states of the cleaning blade 607 and the positioning blade 608 during the cleaning operation.

In FIG. 11A, the positions of the tips of the cleaning blade 607 and the positioning blade 608 are different by a predetermined amount X. In FIG. 11A, Y denotes a free length of the cleaning blade 607, and Z denotes a free length of the positioning blade 608.

In FIG. 11B, since the cleaning portion 601 is always biased against the lens array 506 by the bending of the body portion 603, the position of the cleaning portion 601 is determined by the positioning blade 608 abutting on the lens array 506. The positioning blade 608 always abuts on the lens array 506 during the cleaning operation. The positioning blade 608 is made of urethane rubber similarly to the cleaning blade 607, and has flexibility. However, since a grade having a hardness of 90° measured by a type A durometer is selected, the rubber hardness is high, and the free length (Z in FIG. 11A) is set to be as short as 1.5 mm, the positioning blade 608 does not deform so much as to affect the amount of entry of the cleaning blade 607 even when pressed against the lens array 506.

As described above, the amount of entry of the cleaning blade 607 with respect to the lens array 506 is substantially the same as the difference X between the tips of the cleaning blade 607 and the positioning blade 608. X is determined only by components in the cleaning portion 601, and is not affected by external components such as the solid exposure unit 501 and the main body of the image forming apparatus 100. Therefore, X can be managed with high accuracy of about plus or minus 0.5 mm, and the edge of the cleaning blade 607 properly abuts on the surface of the lens array 506, so that high cleaning ability can be obtained. Even when higher accuracy than 0.5 mm is required, it is possible to perform the assembling while making adjustments since the configuration is completed within the cleaning portion (not shown).

In consideration of the need to suppress deformation of the positioning blade 608, a resin material can also be used as the material of the positioning blade 608 as long as the material does not damage the lens. A material that can be easily deformed such as felt (hardness: about 60° to 70°) or nonwoven fabric is not suitable. In the present embodiment, the dimensions of the blades are set so that the cleaning blade 607 has a thickness of 1 mm, a width of 3.6 mm, and a free length Y of 6.3 mm, and the positioning blade 608 has a thickness of 1 mm, a width of 4.6 mm, and a free length Z of 1.5 mm.

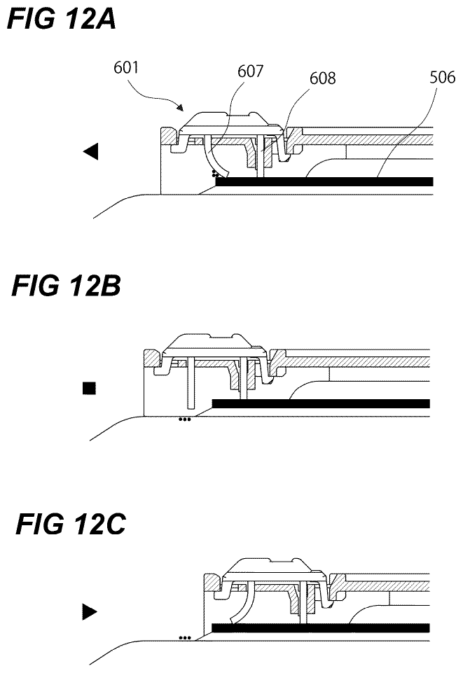

FIGS. 12A to 12C are partial cross-sectional views showing a positional relationship between the lens array 506, the cleaning blade 607, and the positioning blade 608 in a state shown in FIG. 9 in which the cleaning member 600 is inserted deeply and the stopper portion 604 abuts on the insertion guide 550, and before and after the state.

FIG. 12A shows a state immediately before the stopper portion 604 abuts on the insertion guide 550 in the forward path, and the cleaning blade 607 sweeps foreign matter such as a toner on the lens array 506.

FIG. 12B shows a state in which the cleaning member 600 is inserted to the deepest portion where the stopper portion 604 abuts on the insertion guide 550, and in this case, the cleaning blade 607 passes the abutting position at the end portion of the lens array 506 and returns to the free state. The swept foreign matter is thrown to the back of the lens array by reaction when the blade returns to the free state.

FIG. 12C shows a backward path, and the cleaning blade 607 bends in a direction opposite to the forward path. If there is foreign matter left in the forward path, the foreign matter is removed.

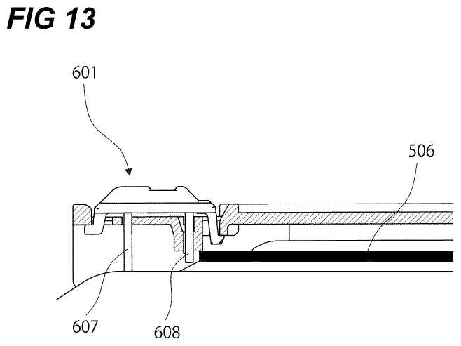

In this way, even in a state in which the cleaning member 600 is inserted to the deepest portion, the positioning blade 608 remains in a state abutting on the end portion of the lens array 506. This is because, as shown in the cross-sectional view of a comparative example in FIG. 13, when the positioning blade 608 passes the lens array 506, the entire cleaning portion 601 loses the support portion and falls off from the lens array 506, and thus when the cleaning member 600 is to be returned to the front side in the backward path, the positioning blade 608 is caught by the end portion of the lens array 506, the operational feeling is significantly deteriorated, and in the worst case, there is a concern that the cleaning member 600 may not be returned. Note that the position of the end portion where the positioning blade remains on the lens array is outside the effective area used for image formation.

As described above, according to the present embodiment, in an image forming apparatus provided with a solid exposure unit, a light emission surface of the solid exposure unit can be reliably cleaned by managing the distance between the solid exposure unit and a cleaning member without providing a guide portion for the cleaning member in the vicinity of the solid exposure unit inside the apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055139, filed Mar. 28, 2025, which is hereby incorporated by reference herein in its entirety.

What is claimed is:

1. A cleaning member for cleaning a light emission surface of a solid exposure unit in an image forming apparatus, the cleaning member comprising:
a cleaning portion provided on one end side of the cleaning member and configured to slide on and clean the light emission surface of the solid exposure unit; and
a gripping portion provided on another end side of the cleaning member and configured to grip the cleaning member,
wherein the cleaning portion includes
a first blade configured to clean the light emission surface of the solid exposure unit by abutting on the light emission surface of the solid exposure unit, and
a second blade configured to manage a position where the first blade abuts on the light emission surface of the solid exposure unit by abutting on the light emission surface of the solid exposure unit, and having a shorter length on a side abutting on the light emission surface of the solid exposure unit than the first blade.

2. The cleaning member according to claim 1, wherein the first blade is provided at a position farther from the gripping portion than the second blade.

3. The cleaning member according to claim 2, further comprising a stopper portion configured to stop entry of the cleaning portion at a predetermined position when the cleaning portion enters a position where the cleaning portion cleans the light emission surface of the solid exposure unit.

4. The cleaning member according to claim 1, further comprising a stopper portion configured to stop entry of the cleaning portion at a predetermined position when the cleaning portion enters a position where the cleaning portion cleans the light emission surface of the solid exposure unit.

5. An image forming apparatus comprising: a guide portion configured to guide the cleaning member according to claim 1 to a position where the cleaning portion cleans the light emission surface of the solid exposure unit,
wherein the guide portion is provided outside the light emission surface of the solid exposure unit in a direction in which the cleaning portion enters, and guides the cleaning portion in a direction in which the cleaning portion abuts on the light emission surface of the solid exposure unit.

6. An image forming apparatus comprising: a guide portion configured to guide the cleaning member according to claim 3 to a position where the cleaning portion cleans the light emission surface of the solid exposure unit,
wherein the guide portion is provided outside the light emission surface of the solid exposure unit in a direction in which the cleaning portion enters, guides the cleaning portion in a direction in which the cleaning portion abuts on the light emission surface of the solid exposure unit, and engages with the stopper portion to stop entry of the cleaning portion at the predetermined position, and at the predetermined position, the first blade is out of an abutting position on the light emission surface of the solid exposure unit, and the second blade is in a state abutting on the light emission surface of the solid exposure unit.
